(19) United States
(12) Patent Application Publication
(10) Pub. No.: US 2009/0110228 A1
(43) Pub. Date: Apr. 30, 2009

(54) SPEAKER DEVICE WITH AUTOMATICALLY RECOVERED RESONANCE SPACE

(75) Inventors: Ta-Wei Chien, Hsinchu City (TW); Jung-Ya Hsieh, Taichung City (TW); Wei-Min Huang, Banciao City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/025,047

(22) Filed: Feb. 3, 2008

(30) Foreign Application Priority Data
Oct. 25, 2007 (TW) 96140062

(51) Int. Cl. H04R 1/02

(52) U.S. Cl. 381/386

(57) ABSTRACT

A speaker device with an automatically recovered resonance space is provided. A flexible speaker is installed in the speaker device, and the flexible characteristic thereof can be fully utilized. When the speaker device is not used, the inner space thereof can be minimized by compression. When the space is minimized, the energy storing unit is provided therein. When the speaker device is used, the energy storing unit releases the stored energy, such that the speaker with the compressed space quickly recovers the resonance space with the speaker. That is, when the speaker device is used, the flexible speaker generates sound, and the sound is resonated in the inner space of the speaker device, thereby enhancing intensity and depth of sound field.

### CROSS-REFERENCE TO RELATED APPLICATION

This application claims the priority benefit of Taiwan application serial no. 96140062, filed on Oct. 25, 2007. The entirety of the above-mentioned patent application is hereby incorporated by reference herein and made a part of this specification.

### BACKGROUND OF THE INVENTION

1. Field of the Invention

The present invention relates to a flexible speaker and products designed by utilizing the speaker. More particularly, the present invention relates to a speaker device with an automatically recovered resonance space.

2. Description of Related Art

In five senses of human being, aural perception and visual perception are pivots of culture progress, and the aural perception is more important. The aural perception receives sound, so spreading of sound becomes one of the key points in human society.

Sounds of the nature come from all directions. This is the natural perception world, the most complete and the most multi-directional sound, and the world to be simulated after human being can catch, store, reproduce, and deliver the sound. Therefore, designing diversity of speakers for reproducing the sound becomes an important technical topic.

For example, recently, it is an important topic of audio engineering how to make the speaker provide sound with high fidelity and satisfy the current demand of being light, thin, short, and small. In common audio-visual room, two speakers are not enough, in order to increase sound source, usually a plurality of speakers are added on left and right sides at back of the audio-visual room. However, lightness of the sound spreading medium is an important factor considered by consumers. Because of limits of technique, material, and related concept, although the speaker has great development in adjustment of size and weight, it is still limited by definitions such as “device”, “perspective space”, and “fixed-point”, that is, it is considered that the speaker is a “device”, an equipment with “perspective space”, and is “fixed”.

It is one of the objectives of the field how to make the speaker develop from the concept, the material, and the technique to correspond to the design demand of the speaker of being lighter, more convenient, more versatile, and more individualized required by the current and future world.

### SUMMARY OF THE INVENTION

Accordingly, the present invention is directed to provide a speaker device with an automatically recovered resonance space. A flexible speaker is installed in the speaker device, and the flexible characteristic thereof can be fully utilized. When the speaker device is not used, the inner space thereof can be minimized by compression. When the space is minimized, the energy storing unit is provided therein. When the speaker device is used, the energy storing unit releases the stored energy, such that the speaker with the compressed space quickly recovers the resonance space with the speaker. That is, when the speaker device is used, the flexible speaker generates sound, and the sound is resonated in the inner space of the speaker device, thereby enhancing intensity and depth of sound field.

In an embodiment, the speaker device with the automatically recovered resonance space includes a flexible speaker and a main body. The flexible speaker is located on at least one side of the main body. The main body further includes a second side and a third side. The second side and the third side are opposite to each other instead of neighboring to each other, and are respectively divided into two folding parts by a diagonal. Each folding part includes a crease, such that when the main body is compressed by an external force, the corresponding folding parts are folded into two half planes with the creases. The speaker device with the automatically recovered resonance space further includes an energy storing disposed therein, such that when the main body is compressed into a flat shape, the energy storing unit stores the energy, and when the external force is removed and it intends to use the main body, the compressed main body automatically recovers the resonance space in the speaker device because the energy storing unit releases the energy.

In an embodiment, the speaker device with the automatically recovered resonance space includes a first cover, a second cover, a flexible speaker, a wrapping layer, and an elastomer. The inner side of the first cover has a spiral thread, and the inner side of the second cover has a spiral teeth for being joined and fixed with the thread of the first cover after rotation. The flexible speaker is fixed on the first cover. The wrapping layer is respectively connected to outer edges of the first cover and the second cover, and forms a resonance space between the first cover and the second cover. The elastomer is located between the upper cover and the lower cover, and is connected to the upper cover and the lower cover.

In order to make the aforementioned and other objects, several features and advantages of the present invention comprehensible, several embodiments accompanied with figures are described in detail below.

It is to be understood that both the foregoing general description and the following detailed description are exemplary, and are intended to provide further explanation of the invention as claim ed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is perspective side view of a speaker device of an embodiment of the present invention.

FIGS. 1B, 1C, and 1D are respectively shape changes of the speaker device after being compressed of the embodiment of FIG. 1A.

FIG. 1E is a schematic view of a side for being folded in the speaker device in the embodiment of FIG. 1A.

FIG. 1F is a perspective side view of a disposed position of an energy storing unit in the speaker device.

FIG. 2A is a perspective side view of a speaker device of another embodiment of the present invention.

FIGS. 2B and 2C are respectively shape changes of the speaker device after being compressed of the embodiment of FIG. 2A.

FIGS. 2D and 2E are schematic views of sides for being folded in the speaker device in the embodiment of FIG. 2A.

FIGS. 3A and 3B are perspective side views of a speaker device of still another embodiment of the present invention in using state and non-using state respectively.

FIGS. 4A and 4B are respectively different embodiments of the composition of the flexible speaker.

### DESCRIPTION OF EMBODIMENTS

A speaker device having elastic space change is introduced herein. The speaker device has a planar flexible speaker fixed on at least one side thereof, and the speaker device is bendable to form different shapes. When the speaker device is not used, the inner space can be minimized by compression, for example, pressed to a flat shape. When the space is minimized, an energy storing unit, such as a spring or an elastic band having elastic force, is disposed therein. When the speaker device is used, the energy storing unit releases the stored energy, such that the speaker device with the compressed space can quickly recover the resonance space with the speaker. That is, when the speaker device is used, the flexible speaker generates sound, and the sound is resonated in the inner space of the speaker device, thereby enhancing intensity and depth of sound field.

The flexible speaker is composed of a sound receiving unit, a conductive electrode, and an electret vibrating-film layer electret vibrating-film layer. The sound receiving unit is connected to the electret vibrating-film layer through the conductive electrode. The sound receiving unit is used to receive an external sound signal, and to convert the sound signal to a potential signal. The potential signal is transmitted to the electret vibrating-film layer through the conductive electrode. The material of the electret vibrating-film layer can select dielectric materials. The dielectric material can maintain static charges for a long time after being electrized, and can generate ferroelectric effect therein after being charged. The electret vibrating-film layer can be a vibrating membrane fabricated by mono-layer or multi-layer dielectric material, and the dielectric material can be, for example, fluorinated ethylenepropylene (FEP), polytetrafluorethylene (PTFE), polyvinylidene fluoride (PVDF), some Fluorine Polymer, and other suitable materials. The electret vibrating-film layer is a vibrating membrane capable of maintaining the static charges and piezoelectricity for a long time after the dielectric material is electrized, so after being charged by corona, dipolar charges are generated in the material to generate the ferroelectric effect. The sound signal is converted to the potential signal, and is transmitted to the electret vibrating-film layer through the conductive electrode to generate sound. Different voltage values of the potential signal can make the electrets generate sound with different frequencies.

In another alternative embodiment, the flexible speaker can be composed of an input port, a conductive electrode, and en electret vibrating-film layer. An external sound receiving unit can convert the sound signal to the potential signal, and transmit the potential signal to the conductive electrode through the input port, till it is transmit to the electret vibrating-film layer to generate sound.

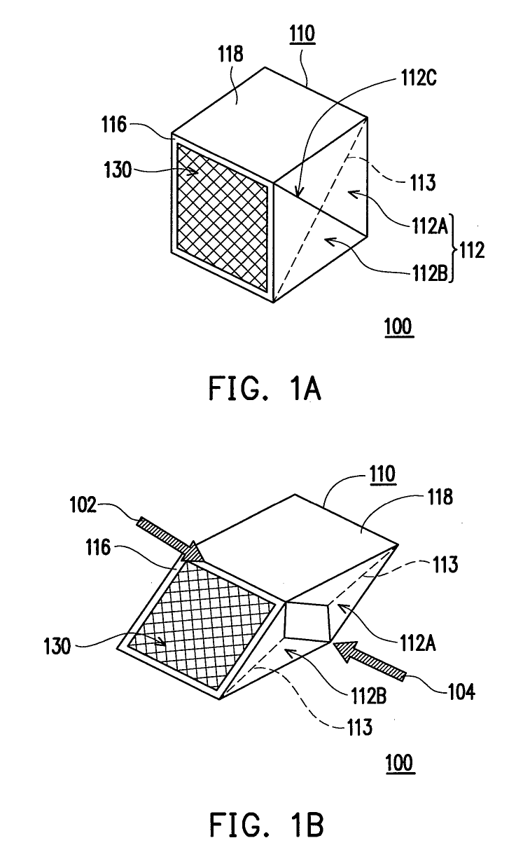

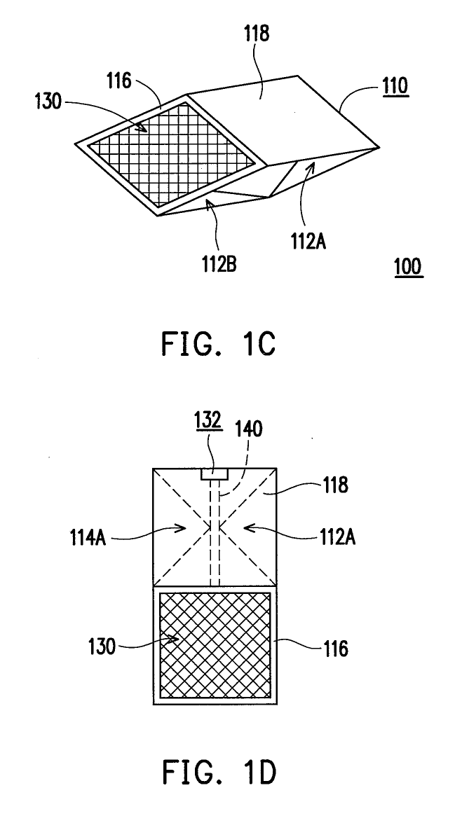

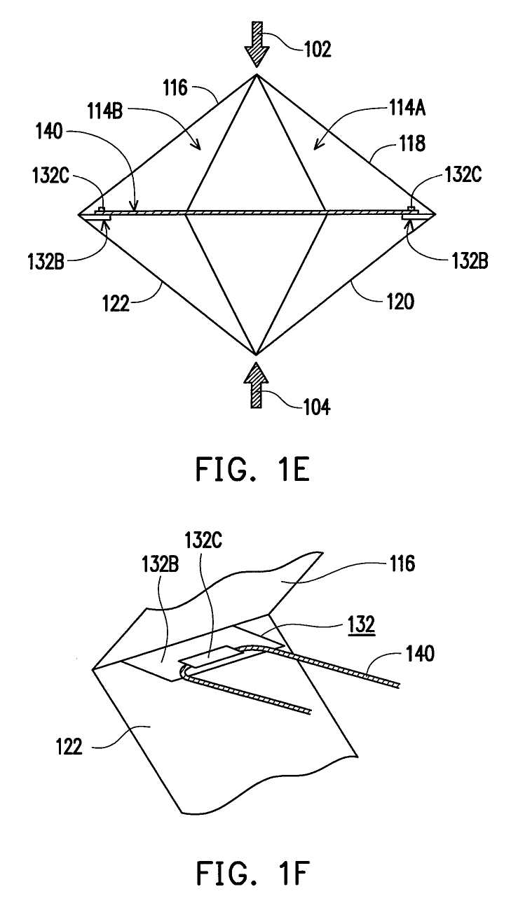

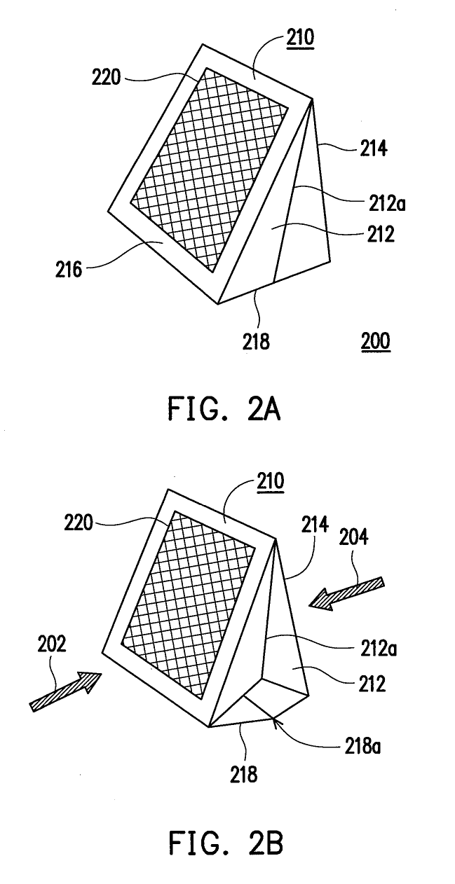

Referring to FIGS. 1A-1F, schematic views of an embodiment of the speaker device having elastic space changes provided by the present invention are shown. FIG. 1A is a perspective side view of the speaker device, FIGS. 1B, 1C, and 1D illustrate shapes of the speaker device after being compressed, and FIGS. 1E and 1F are schematic views of the disposing position of the energy storing unit in the speaker device. Firstly, referring to FIGS. 1A-1D, a speaker device 100 includes a main body 110 and a flexile speaker. The main body 110 can be, for example, made of thicker paper material, or made of flexible soft material. The flexible speaker, for example, includes a sound receiving unit, a conductive electrode, and an electret vibrating-film layer. However, for convenience of illustration, in the figures, only an electret vibrating-film layer 130 fixed on one side 116 of the main body 110 is shown.

Please refer to the perspective side view of the speaker device of FIG. 1A and the shapes of the speaker device after being compressed as shown in FIGS. 1B, 1C, and 1D. When being used, the main body 110 has a three-dimensional shape, and when the flexible speaker generates sound, the sound is resonated in the main body 110, thus increasing the intensity and the depth of the sound field. The main body 110 includes six sides 112, 114, 116, 118, 120, and 122, in which the sides 112 and 114, 116 and 120, and 118 and 122 are respectively two opposite sides without being neighbored.

The opposite sides without being neighbored 112 and 114 of the main body 110 are respectively divided into two folding parts 112A, 112B and 114A, 114B through diagonals 112C and 114C (not shown on the opposite side, but structures of the sides 112 and 114 are the same). Each folding part includes a crease, as shown in the drawing, the folding parts 112A and 112B have a crease 113, and the folding parts 114A and 114B on the other side also has a crease 113. When the speaker device 100 is compressed, because of the compression of the external force, the folding parts 112A, 112B and 114A, 114B are respectively folded into two half planes through the creases 113. Therefore, as shown in FIG. 1B, when external forces 102 and 104 are applied to crossing edge (i.e. two ends of 112C and 114C) of the sides 116 and 118 and sides 120 and 122, the creases 113 have been formed on the folding parts 112A, 112B and 114A, 114B. Therefore, according to inertia, the side folding parts 112A, 112B and 114A, 114B are respectively folded into two half planes along the creases 113 to be overlapped. At the same time, the whole main body 110 is compressed to a flat shape, as shown in FIG. 1C. As shown in FIG. 1D, the whole main body 110 is flattened. The volume of the compressed speaker device becomes quite small, and it is quite convenient to carry.

For the speaker device 100 provided by this embodiment, if it is compressed to the flat state, it can be fixed by any external fixing device, such as elastic band or fixing clamp having the elastic force. When the user begins to use, the fixing device can be removed. At this time, the speaker device 100 has an energy storing unit, such as a spring or an elastic band having the elastic force. Referring to FIGS. 1E and 1F, schematic views of the disposed position of the energy storing unit in the speaker device are shown. Here, an elastic element such as an elastic band is used as an example, but it is not limited here. After fixing units 132 are respectively added at corners of two opposite angles in the main body, i.e., the central position of the corner of the two planes, the elastic band is connected to the two fixing units to serve as the energy storing element. For example, in FIG. 1E, the fixing unit 132 is respectively disposed on the corner where the neighboring sides 116 and 122 are connected and the corner where the neighboring sides 118 and 120 are connected. The fixing unit 132 includes a base portion 132B and an extending clamping portion 132C on the base portion 132B, such that the elastic element 140 is movably placed and fixed between the two clamping portions 132C. For the detailed drawing, please refer to FIG. 1F, the fixing unit 132 is located on the central position of the corner where the neighboring sides 116 and 122 are connected, and the elastic element elastic band 140 can be fixed through the clamping portion 132C. The design is an active concept, and the elastic element 140 can be removed or replaced.

When the whole main body 110 is compressed to a flat shape, external forces 102 and 104 are applied on the elastic element 140, so the elastic element 140 is elongated and tightened. When the external force is removed to begin to use the speaker device 100, the elastic element, for example the elastic band 140, releases the stored energy in a spring back manner, such that the speaker device with the compressed space can automatically and quickly recover the three-dimensional resonance space with the speaker. The elastic element, e.g., the elastic band 140, can be replaced by other elements, such as a spring, as long as the external force is applied to compress the main body 110, the energy is stored, when it begins to use the speaker device 100, the external force is removed to automatically form the speaker device 100 having the resonance space.

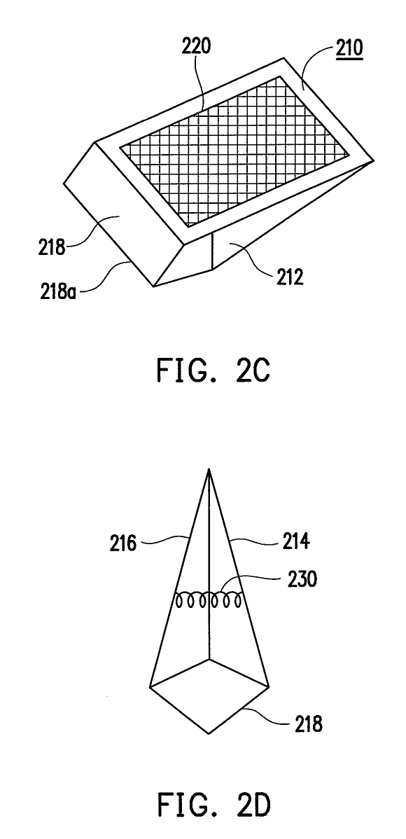

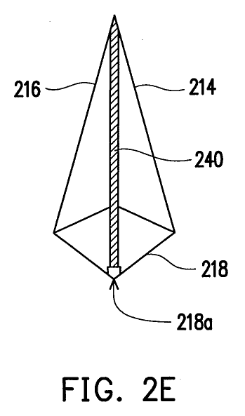

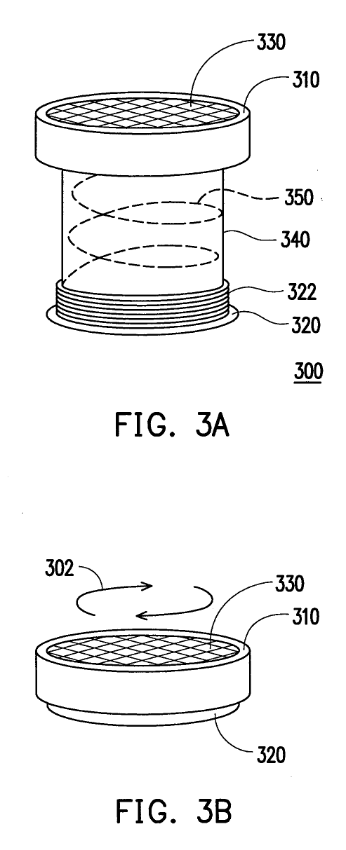

FIGS. 2A-2E are schematic views of the speaker device having elastic space change according to another embodiment of the present invention. FIG. 2A is a perspective side view of the speaker having a triangle cube shape, FIGS. 2B and 2C illustrate shapes of the speaker device after being compressed, and FIGS. 2D and 2E are schematic views of the position of the energy storing unit disposed in the speaker device, here cross-sectional views are used for illustration. Firstly, referring to FIGS. 2A-2C, the speaker device 200 includes a main body 210 and a flexible speaker. The flexible speaker includes, for example, a sound receiving unit, a conductive electrode, and an electret vibrating-film layer. However, for convenience of illustration, in the drawing, only an electret vibrating-film layer 220 fixed on one side 216 of the main body 210 is shown.

FIG. 2A is a perspective side view of the speaker device 200. At this time, when being used, the main body 210 forms a three-dimensional shape, and when the flexible speaker generates sound, the sound is resonated in the main body 210, thus increasing the intensity and the depth of the sound field. A side 212 of the main body 210 has a crease 212a, and another side opposite to the side 212 also has a crease, which is not described herein. The side 212 and the opposite side and a bottom face 218 are all divided. After the speaker device 200 is compressed, the side 212 and the other side can be compressed by the external force and are respectively folded into two half planes through the crease 212a and the crease of the other side.

Therefore, as shown in FIG. 2B, when external forces 202 and 204 are applied to the side 216 and the other side 214 opposite to it, the crease 212a is formed on the side 212 of the main body 210 and on the other opposite side. Therefore, according to inertia, the side 212 and the other opposite side are folded into two half planes along the crease 212a and the crease of the other side for being overlapped together. The speaker device 200 is a triangle three-dimensional shape, so the bottom plane 218 of the main body 210 also has a crease 218a, when the external forces 202 and 204 are applied to the side 216 and the opposite side 214, the bottom plane 218 is also folded into two half planes for being overlapped together, referring to FIG. 2C. At this time, the whole main body 210 is compressed into a flat shape. After the whole main body 210 is flattened, the volume becomes quite small, and it is quite convenient to carry.

The energy storing unit in the speaker device 200 can adopt any current design. In an embodiment, as shown in FIG. 2D, the elastic element, for example the spring is used for illustration. An elastic element, for example the spring 230, is disposed between the side 216 and the opposite side 214. When the main body 210 is a three-dimensional shape, the elastic element 230 is of a natural length. When the whole main body 210 is compressed by the external force to form the flat shape, the elastic element, for example the spring 230, is tightened due to the application of the external force. When the external force is removed for beginning to use the speaker device 200, the elastic element 230 releases the stored energy in a manner of springing back to the original natural length, such that the speaker with the compressed space can automatically and quickly recover the resonance space with the speaker. The bottom plane 218 has the crease 218a, so when the external force is applied to the sides 216 and 214, the bottom plane 218 is also folded into two half planes for being overlapped together. The inward manner (i.e., accommodating into the main body 210) and the outward manner (extending outwards the main body 210) are alternative implementation manners.

As shown in FIG. 2E, in another embodiment, the energy storing unit in the speaker device 200 can be an elastic element, for example, an elastic band 240 connected between the corner where the sides 216 and 214 are connected and the bottom plane 218, for example, located on the central position of the three-dimensional triangle. When the main body 210 is the three-dimensional shape, the elastic element 240 is of a natural length. When the whole main body 210 is compressed into the flat shape, the bottom plane 218 is folded into two half planes and are overlapped outwards, such that the elastic element, for example the elastic band 240, is stretched by the external force to be tightened. When the external force is removed, and it begins to use the speaker device 200, the elastic element 240 releases the stored energy in the manner of springing back to the natural length, such that the speaker device with the compressed space can automatically and quickly recover the resonance space with the speaker. Particularly, the bottom plane 218 has a crease 218a, so when the external force is applied to the sides 216 and 214, the bottom plane 218 is also folded into two half planes for being overlapped together. However, in consideration that the elastic element, for example the elastic band 240, must store the energy when the main body 210 is compressed to the flat shape, so it can only extend and protrude towards the main body 210.

When the speaker device 100 or 200 provided by the embodiments is compressed to the flat state, it can be fixed by any external fixing device, such as an elastic band or a fixing clamp having the elastic force. When the user begins to use, the fixing device can be removed. At this time, the speaker device 100 or 200 has an energy storing unit, such as a spring or an elastic band having the elastic force, capable of making the speaker device 100 or 200 be recovered to the three-dimensional shape.

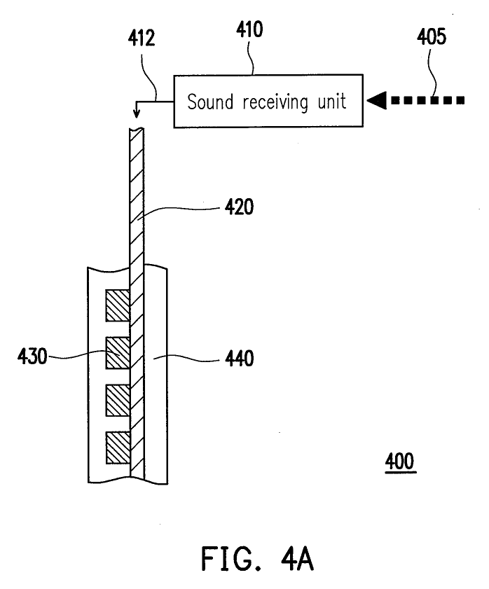

FIGS. 3A-3B are schematic views of the speaker device having the elastic space change according to still another embodiment of the present invention. FIG. 3A is a schematic side view of the speaker device having cylindrical three-dimensional shape, and FIG. 3B illustrates the shape of the speaker device after being compressed and fixed.

Firstly, referring to FIG. 3A, the speaker device 300 includes an upper cover 310, a lower cover 320, and a flexible speaker. The flexible speaker includes, for example, a sound receiving unit, a conductive electrode, and an electret vibrating-film layer. However, for convenience of illustration, only a part of the electret vibrating-film layer 300 fixed on the upper cover 310 is shown in the drawing. The upper cover 310 and the lower cover 320 can be fixed by using spiral teeth and spiral thread through rotation, for example the upper cover 310 in FIG. 3A has the spiral thread, and the lower cover 320 has the spiral teeth 322. In order to form the resonance space of the speaker device, when the speaker device 300 is used, an elastic element 350, for example a spring, is added between the upper cover 310 and the lower cover 320, so as to push off the upper cover 310 and the lower cover 320 to form a resonance space. At this time, the elastic element 350 has a natural length. In addition, a wrapping layer 340 made of soft material, such as cloth or plastic layer, is added to the outer edges between the upper cover 310 and the lower cover 320.

If the speaker device 300 provided by this embodiment is not used, the upper cover 310 and the lower cover 320 can be fixed through rotation by applying an external force 302. At this time, the elastic element 350 disposed therein is tightened due to the application of the external force 302. When it begins to use the speaker device 300, after the upper cover 310 and the lower cover 320 are unscrewed, the elastic element 350 releases the stored energy in the manner of springing back to the natural length, such that the speaker device with the compressed space can automatically and quickly recover the resonance space with the speaker.

In another embodiment, the upper cover 310 and the lower cover 320 can be fixed by buckling. At this time, the external force is a downward pressing force. In another embodiment, the upper cover 310 and the lower cover 320 may not have a fixing design, after the external force is applied to press the two together, they may be fixed by using an elastic band or a fixing clamp having the elastic force.

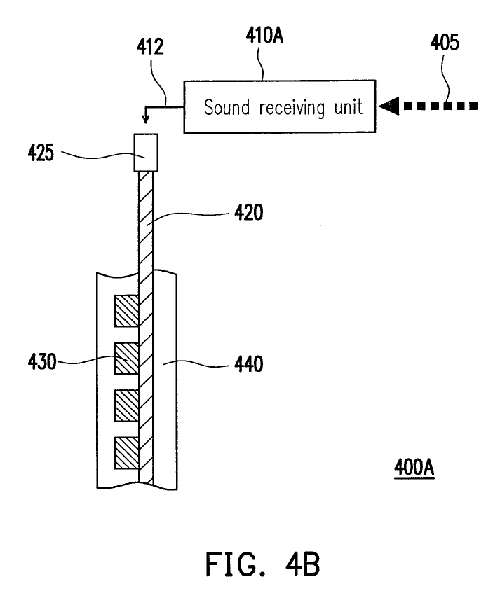

Referring to FIG. 4A, the embodiment of the composition of the flexible speaker is illustrated. A flexible speaker 400 is composed of a sound source receiving unit 410, a conductive electrode 420, and an electret vibrating-film layer 430, and is embedded or fixed in or on a substrate 440, for example, in or on the side of the main body of each embodiment. The sound source receiving unit 410 is connected to the electret vibrating-film layer 430 through the conductive electrode 420. The sound source receiving unit 410 is used to receive an external sound signal 405, and to convert the sound signal 405 to a potential signal 412. The potential signal 412 is transmitted to the electret vibrating-film layer 430 through the conductive electrode 420. The electret vibrating-film layer 430 is a vibrating membrane capable of maintaining the static charges and piezoelectricity for a long time after the dielectric material is electrized, so after being charged by corona, dipolar charges are generated in the material to generate the ferroelectric effect. The sound signal 405 is converted to the potential signal 412, and is transmitted to the electret vibrating-film layer 430 through the conductive electrode 420 to generate sound. Different voltage values of the potential signal 412 can make the electrets generate sound with different frequencies.

Referring to FIG. 4B, a further embodiment of the composition of the flexible speaker is illustrated. It is different from FIG. 4A that the flexible speaker 400A includes an input port 425. The sound source receiving unit 410A is an external device, and is not disposed in the flexible speaker 400A. The external sound source receiving unit 410A can convert the sound signal 405 to the potential signal 412, and the potential signal 412 is transmitted to the conductive electrode 420 through the input port 425, and then directly transmitted to the electret vibrating-film layer 430 to generate sound.

To sum up, the present invention provides a speaker device with an automatically recovered resonance space. The flexible speaker is installed on the speaker device, and the flexible characteristic thereof can be fully utilized. When the speaker device is not used, the inner space thereof can be minimized by compression. When the space is minimized, the energy storing unit is provided therein. When the speaker device is used, the energy storing unit releases the stored energy, such that the speaker with the compressed space quickly recovers the resonance space with the speaker. That is, when the speaker device is used, the flexible speaker generates sound, and the sound is resonated in the inner space of the speaker device, thereby enhancing intensity and depth of sound field.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A speaker device with an automatically recovered resonance space, comprising:
a flexible speaker;
a main body, wherein the flexible speaker is located on at least one side of the main body, the main body further comprises a second side and a third side, the second side and the third side are respectively divided into two folding parts through a diagonal, and each folding part comprises a crease, such that after the main body is compressed by an external force, the folding parts corresponding to the second and the third sides are folded into two half planes through the creases; and
an energy storing unit, located inside the main body, wherein when the main body is compressed into a flat shape, the energy storing unit stores energy, and when the main body is used for generating sound, the energy storing unit releases the energy, and the compressed main body automatically recovers the resonance space in the speaker device.

2. The speaker device as claimed in claim 1, wherein the main body is a regular cube shape.

3. The speaker device as claimed in claim 2, wherein the energy storing unit is fixed on central positions of two opposite corners in the main body, and is perpendicular to the diagonals.

4. The speaker device as claimed in claim 2, wherein the energy storing unit is an elastic band, respectively fixed on two fixing units at the central position of the two opposite corners in the main body in a removable manner.

5. The speaker device as claimed in claim 1, wherein the flexible speaker at least comprises an electret vibrating-film layer fixed on the side of the main body.

6. The speaker device as claimed in claim 5, wherein the electret vibrating-film layer is composed of dielectric material, and the dielectric material maintains static charges for a long time after being electrized, and generates ferroelectric effect in the material after being charged.

7. The speaker device as claimed in claim 1, wherein the flexible speaker comprises:
a sound source receiving unit, for receiving an external sound signal, and converting the sound signal to a potential signal;
an electret vibrating-film layer, fixed on the side of the main body; and
a conductive electrode, for connecting the sound receiving unit and the electret vibrating-film layer, transmitting the potential signal to the electret vibrating-film layer, and generating sound accordingly.

8. The speaker device as claimed in claim 1, wherein the flexible speaker comprises:
an input port, for receiving an external potential signal;
an electret vibrating-film layer, fixed on the side of the main body; and
a conductive electrode, for connecting the input port and the electret vibrating-film layer, transmitting the potential signal to the electret vibrating-film layer, and generating sound accordingly.

9. A speaker device with an automatically recovered resonance space, comprising:
a first cover;
a second cover, for being joined with the first cover;
a flexible speaker, fixed on the first cover;
a wrapping layer, respectively connected to outer edges of the first cover and the second cover, and forming a resonance space between the first cover and the second cover; and
an energy storing unit, located between the upper cover and the lower cover, and connected to the upper cover and the lower cover.

10. The speaker device as claimed in claim 9, wherein the first cover and the second cover are round.

11. The speaker device as claimed in claim 9, wherein the energy storing unit is a spring.

12. The speaker device as claimed in claim 9, wherein the flexible speaker at least comprises an electret vibrating-film layer fixed on the side of the main body.

13. The speaker device as claimed in claim 12, wherein the electret vibrating-film layer is composed of a dielectric material, and the dielectric material maintains static charges for a long time after being electrized, and generates ferroelectric effect in the material after being charged.

14. The speaker device as claimed in claim 9, wherein the flexible speaker comprises:
a sound receiving unit, for receiving an external sound signal, and converting the sound signal to a potential signal;
an electret vibrating-film layer, fixed on the side of the main body; and
a conductive electrode, for connecting the sound receiving unit and the electret vibrating-film layer, transmitting the potential signal to the electret vibrating-film layer, and generating sound accordingly.

15. The speaker device as claimed in claim 9, wherein an inner side of the first cover and an inner side of the second cover respectively have a spiral thread and a spiral teeth, for joining and fixing the inner side of the first cover and the second cover after rotation.

16. The speaker device as claimed in claim 9, wherein the first cover and the second cover respectively have a buckling device, for buckling with each other after being applied by an external force.

17. A speaker device with an automatically recovered resonance space, comprising:
a flexible speaker;
a main body, wherein the flexible speaker is located on at least one side of the main body, the main body further comprises a second side, a third side and a fourth side, the second side, the third side and the fourth side respectively comprise a crease, such that after the main body is compressed by an external force, the corresponding second side, third side and the fourth side are folded into two half planes with the creases; and
an energy storing unit, located in the main body, wherein when the main body is compressed into a flat shape, the energy storing unit stores energy, and when the main body is used, the energy storing unit releases the energy, and the compressed main body automatically recovers the resonance space in the speaker device.

18. The speaker device as claimed in claim 17, wherein the main body is a triangle cube shape.

19. The speaker device as claimed in claim 18, wherein the energy storing unit is a spring connected between the second side and the third side, when the main body is the triangle cub shape and is not compressed, the spring has natural length, when the main body is compressed, the spring stores the energy because of being compressed.

20. The speaker device as claimed in claim 18, wherein the energy storing unit is an elastic band, one end thereof is connected to central position of a corner where the second side and the third side are connected, and the other end thereof is connected to the fourth side, when the main body is the triangle cube shape and is not compressed, the elastic band has the natural length, and when the main body is compressed, the spring stores the energy because of being elongated and extended.

21. The speaker device as claimed in claim 20, wherein when the main body is compressed, the fourth side bends towards the external of the main body.

22. The speaker device as claimed in claim 17, wherein the flexible speaker at least comprises an electret vibrating-film layer fixed on the side of the main body.

23. The speaker device as claimed in claim 22, wherein the electret vibrating-film layer is composed of a dielectric material, and the dielectric material maintains static charges for a long time after being electrized, and generates ferroelectric effect in the material after being charged.

24. The speaker device as claimed in claim 17, wherein the flexible speaker comprises:
a sound source receiving unit, for receiving an external sound signal, and converting the sound signal to a potential signal;
an electret vibrating-film layer, fixed on the side of the main body; and
a conductive electrode, for connecting the sound receiving unit and the electret vibrating-film layer, transmitting the potential signal to the electret vibrating-film layer, and generating sound accordingly.

25. The speaker device as claimed in claim 17, wherein the flexible speaker comprises:
an input port, for receiving an external potential signal;
an electret vibrating-film layer, fixed on the side of the main body; and
a conductive electrode, for connecting the input port and the electret vibrating-film layer, transmitting the potential signal to the electret vibrating-film layer, and generating sound accordingly.
